(19) United States
(12) Patent Application Publication
(10) Pub. No.: US 2021/0347192 A1
(43) Pub. Date: Nov. 11, 2021

(54) BOOK WITH RESILIENT ELEMENT

(71) Applicant: Cottage Door Press, LLC, Rolling Meadows, IL (US)

(72) Inventors: Richard G. Maddrell, Barrington, IL (US); Lisa E. Gelfond, Chicago, IL (US)

(73) Assignee: Cottage Door Press, LLC, Rolling Meadows, IL (US)

(21) Appl. No.: 16/869,302

(22) Filed: May 7, 2020

(51) Int. Cl. B42D 3/12; A61J 17/00

(52) U.S. Cl. CPC B42D 3/12; A61J 17/111

(57) ABSTRACT

A book having a chewable element or a portion that can be used as a teether or a teething element, for example, for child to get dental stimulation when the child inserts the book or a part of the book into a mouth. The book includes a plurality of pages and a spine positioned along edge portions of the pages. The edge portions of the pages can be secured directly or indirectly to the chewable element or the portion. The chewable element can have a bore to accommodate a ring. A second or another chewable element can be secured or positioned at a distance from the first chewable element.

### BACKGROUND OF THE INVENTION

### Field of the Invention

This invention relates to a book that has a chewable element or a resilient portion constructed to withstand a child or other person inserting the book into a mouth and using it as a chewing toy, a teething device or for other teething purposes.

### Discussion of Related Art

Many conventional books used by children or other similar users have durable pages or covers that can be inserted into a mouth of the child or user. Pages and covers of the conventional books are often destroyed by moisture from a mouth and chewing forces generated and applied to the pages or covers.

Some conventional books are constructed of relatively durable pages, including materials similar to polyethylene fibers or other fiber synthetic materials. The structures of many conventional books are destroyed, particularly when the pages or covers of the books are inserted into or exposed to a mouth of a child or another similar user and the chewing forces generated by the child or other user.

There is an apparent need for a book that is appealing to a child and that can be safely inserted in a mouth or positioned near eyes of a child and not injure, harm or otherwise hurt the child.

### SUMMARY OF THE INVENTION

It is one object of this invention to provide a book or pamphlet that can be inserted into the mouth of a person, such as a child or another similar user, and that can withstand the moisture and forces generated by the child or other user.

The above and other objects of this invention can be accomplished with a book that has a chewable element or a resilient element covering at least a portion of pages and/or covers of the book. The pages and/or covers can be attached or secured to the chewable element or resilient element with any suitable securement or securing device.

In some embodiments of this invention, the chewable element has a bore extending through a body of the chewable element. The bore can accommodate a link, a ring and/or another suitable device for attaching two or more books with respect to each other.

According to some embodiments of this invention, a second chewable element is also attached to the book. In some embodiments of this invention, each chewable element has a teether surface on an exterior of the chewable element and the teether surface can be used, for example, to stimulate or rub the gums within a mouth.

### BRIEF DESCRIPTION OF THE DRAWINGS

This invention is explained in greater detail below in view of exemplary embodiments shown in the drawings, wherein:

FIG. 1 is a perspective view of a book assembly, according to one embodiment of this invention;

FIG. 2 is a front view of a book assembly, according to one embodiment of this invention;

FIG. 3 is a front view of a book assembly, according to one embodiment of this invention;

FIG. 4 is a rear view of the book assembly, as shown in FIG. 3;

FIG. 5 is a side view of the book assembly, as shown in FIGS. 3 and 4;

FIG. 6 is a front view of a book assembly, according to one embodiment of this invention;

FIG. 7 is a front view of a chewable element, according to one embodiment of this invention;

FIG. 8 is a front view of a chewable element, according to one embodiment of this invention;

FIG. 9 is a cross-sectional view of the chewable element, as shown in FIG. 8;

FIG. 10 is a perspective view of a book assembly, according to one embodiment of this invention;

FIG. 11 is a perspective view of a book assembly, according to one embodiment of this invention;

FIG. 12 shows front views according to five different embodiments of a book assembly according to this invention;

FIG. 13 shows a front view of a book assembly, according to one embodiment of this invention;

FIG. 14 shows a front view of a book assembly, according to one embodiment of this invention;

FIG. 15 shows a perspective view of a book assembly, according to one embodiment of this invention;

FIG. 16 shows a perspective view of a book assembly, according to one embodiment of this invention; and

FIG. 17 shows three different embodiments of a book assembly, according to different embodiments of this invention.

### DETAILED DESCRIPTION OF THE INVENTION

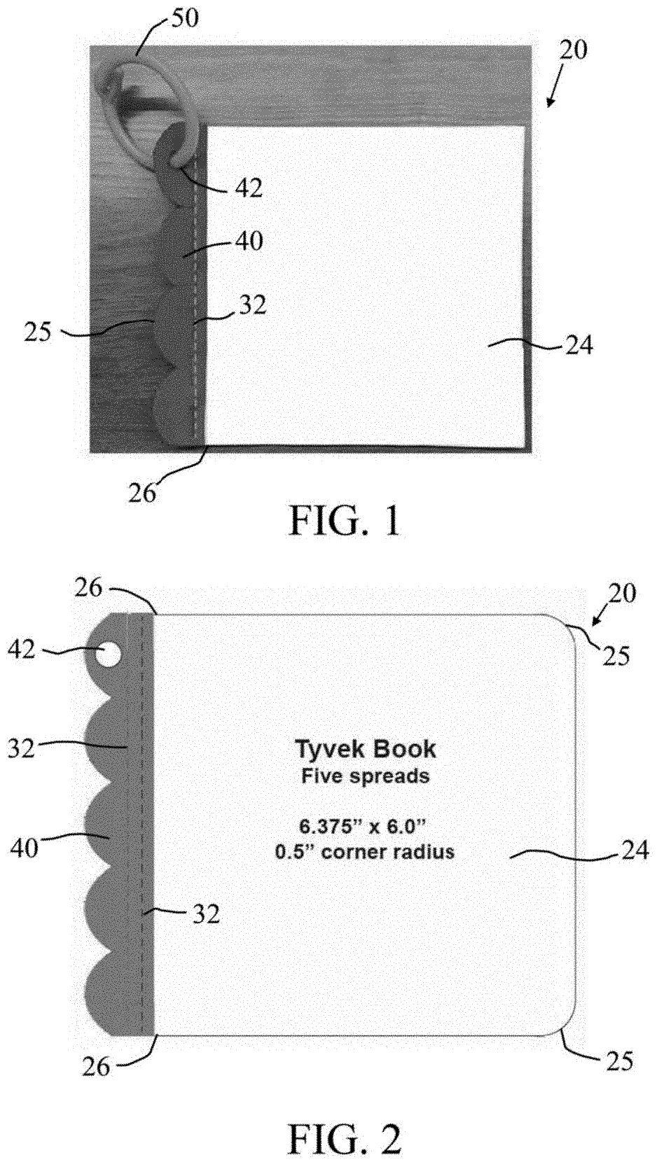

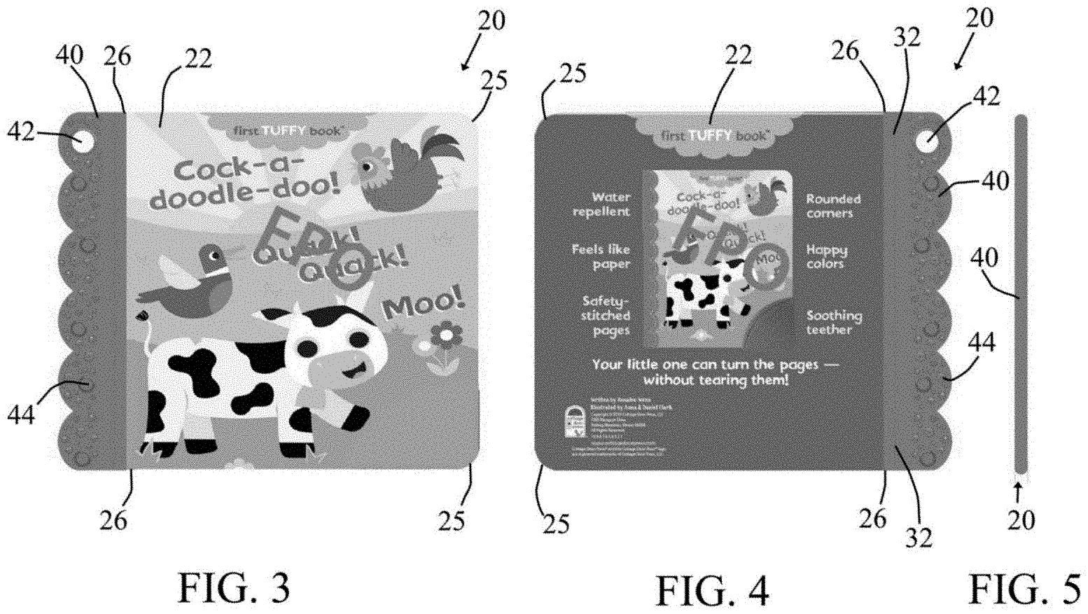

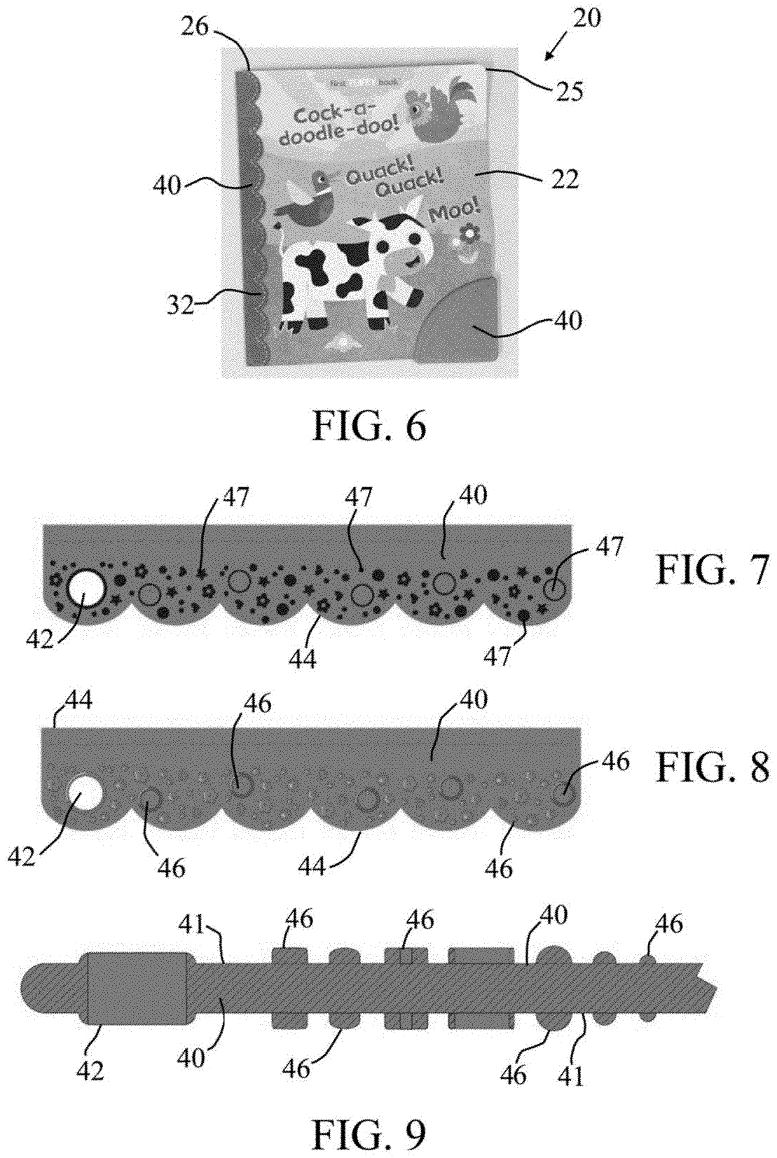

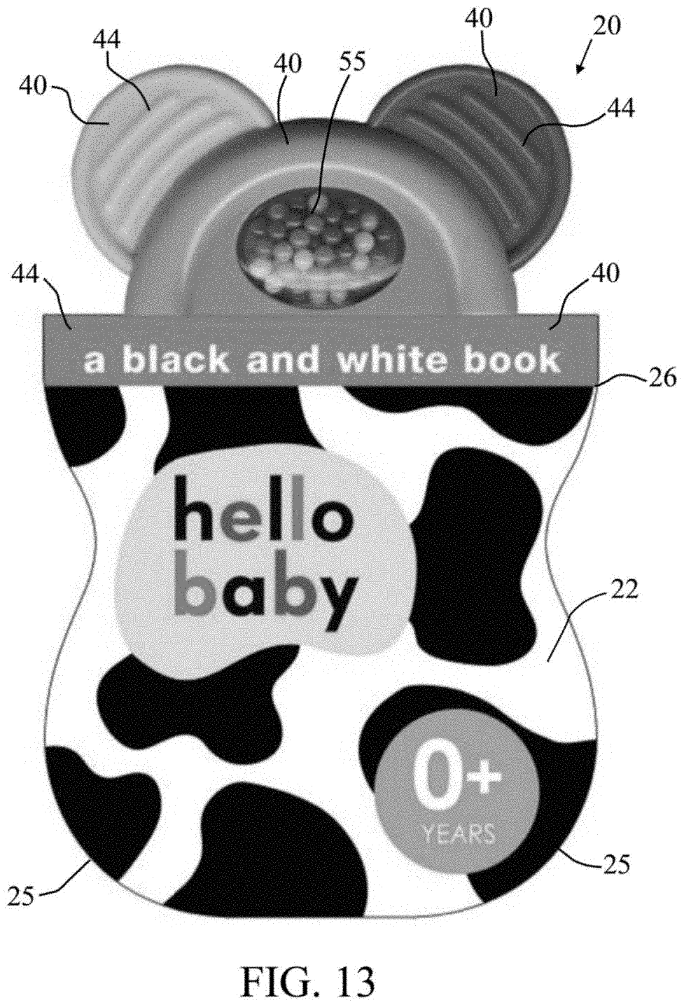

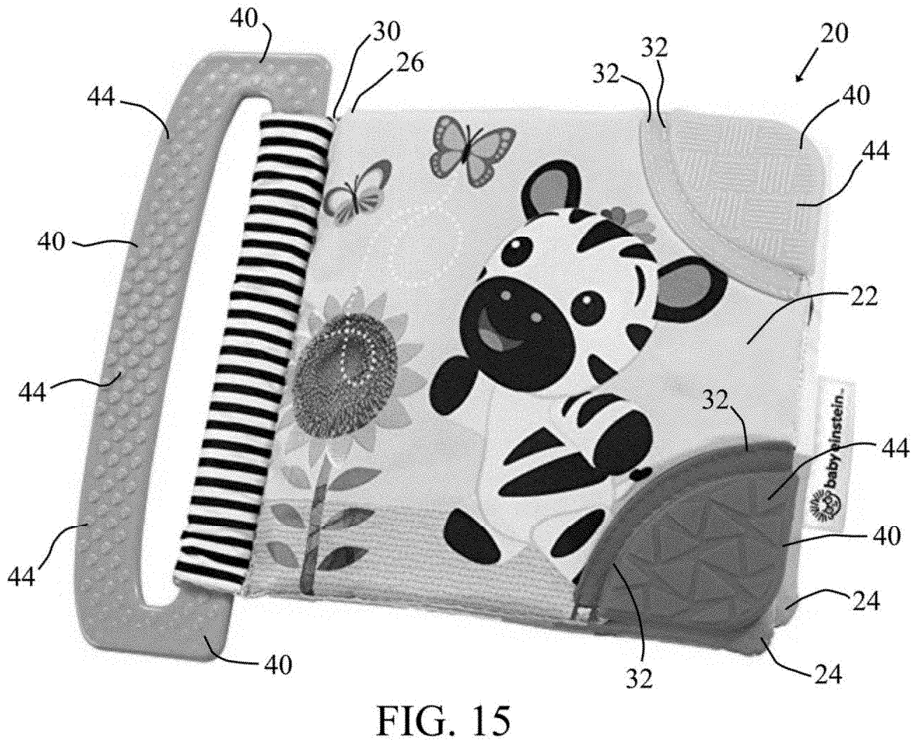

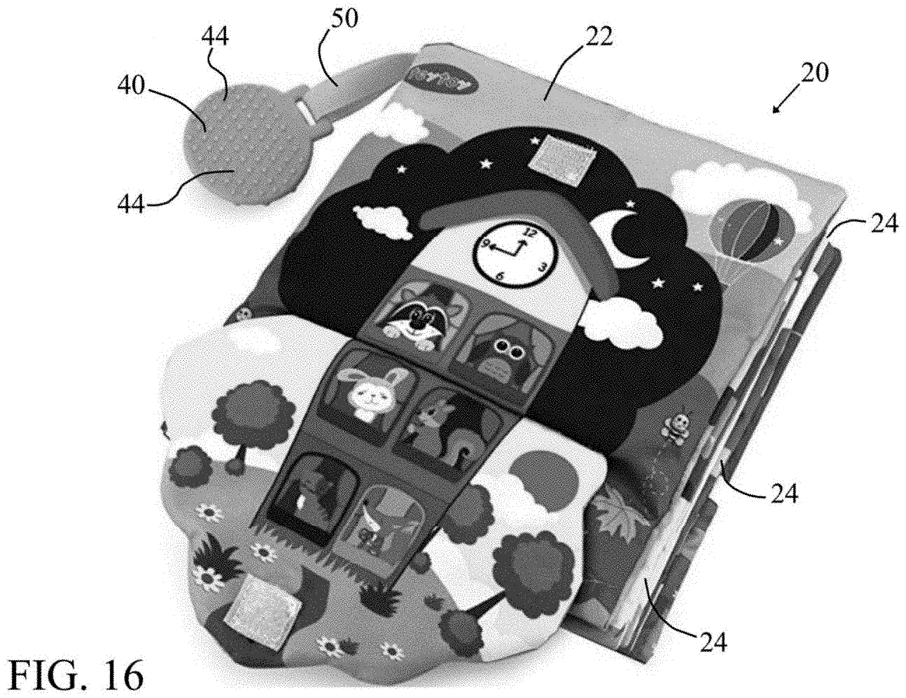

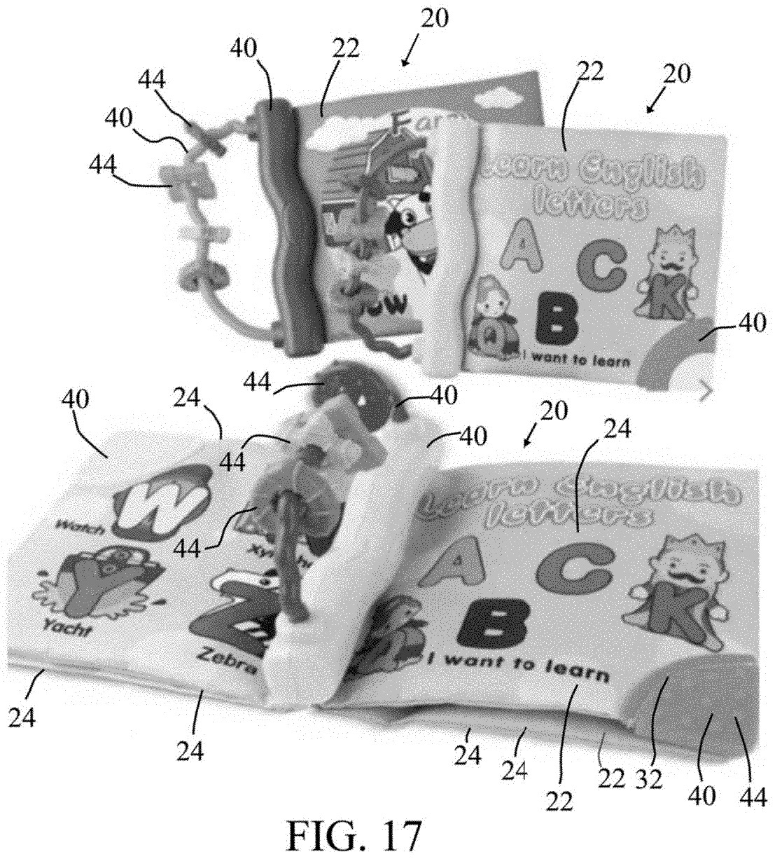

FIGS. 1-17 show different views of book 20, according to different embodiments of this invention. Many of the different elements shown in FIGS. 1-17 can be interchanged with each other and/or replaced with other similar elements, to form several other different embodiments of features of book 20, according to this invention, that accomplish the same and/or similar results of this invention.

FIG. 1 shows a perspective view of book 20 with link 50 routed through or passing through bore 42 of chewable element 40, according to one embodiment of this invention. As shown in FIG. 1, only one book 20 is connected to and/or otherwise attached directly or indirectly to link 50 but in other embodiments of this invention, a plurality of or multiple books 20 can be connected to and/or otherwise attached to link 50. FIG. 16 shows another embodiment of link 50 connected to and/or otherwise attached to book 20.

FIGS. 1-6, 10-12 and 15-17 show different embodiments of book 20 comprising a plurality of pages 24. In some embodiments of this invention, the overall shapes of pages 24 are the same or similar to each other, so that pages 24 stack and form a consistent overall shape of an assembled book 20. In other embodiments of this invention, the overall shapes of pages 24 can be different from each other, so that pages 24 stack and form an inconsistent or irregular overall shape of an assembled book 20.

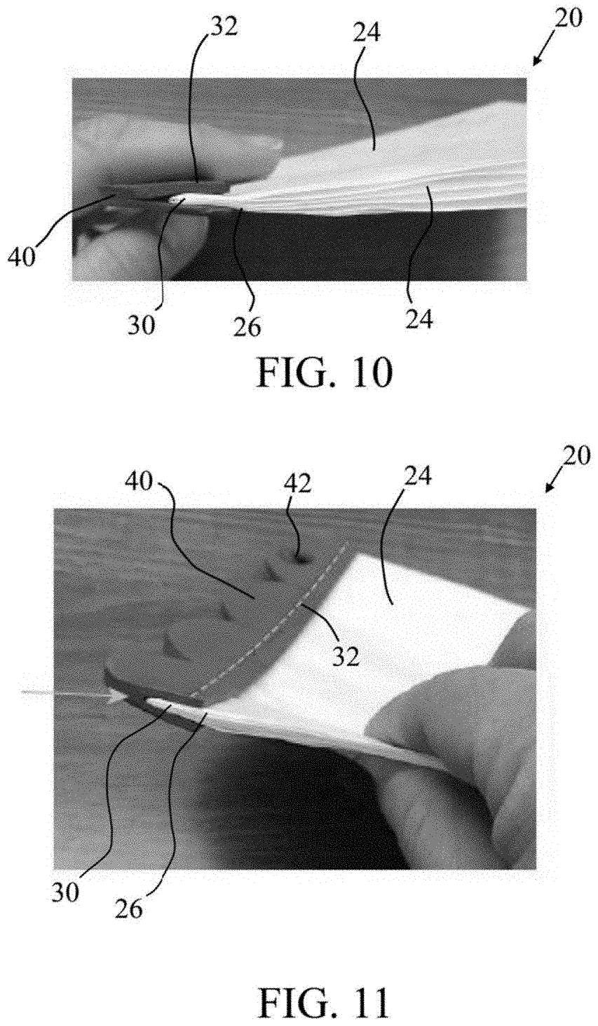

In some embodiments of this invention, for example as shown in FIGS. 10 and 11, edge portions 26 of pages 24 are stacked at or near spine 30. In some embodiments of this invention, pages 24 are folded at or near spine 30 and pages 24 are stacked with respect to each other. In other embodiments of this invention, pages 24 are not folded but rather are individually or separately cut to form individual or separate pages 24 and are also stacked with respect to each other to form a uniformly overall shaped or a non-uniformly overall shaped book 20.

In some embodiments of this invention, chewable element 40 at least partially or fully covers edge portions 26, for example, to structurally hold and/or aesthetically cover or hide at least a portion of each edge portion 26, particularly with respect to chewable element 40. In some embodiments of this invention, each edge portion 26 and/or page 24 is secured, attached and/or otherwise held in position either directly or indirectly with respect to chewable element 40, page 24, rattle 55 and/or any other element or part of book 20.

According to some embodiments of this invention, thread 32 is used to secure, attach and/or otherwise hold chewable element 40 directly or indirectly with respect to edge portion 26, page 24, rattle 55 and/or any other element or part of book 20. FIGS. 1-4, 6 and 10-17 show different layouts or positions of the routing or direction of stitching of thread 32 with respect to chewable element 40, edge portion 26, page 24, rattle 55 and/or any other element or part of book 20. In some embodiments of this invention, thread 32 can be replaced with or used in addition to another suitable attachment, securement and/or any other securing method, for example, an adhesive, a heat seal and/or any other suitable method for securing or attaching chewable element 40 with respect to edge portion 26, page 24, rattle 55 and/or any other part of book 20.

In some embodiments of this invention, it can be important for pages 24, rattle 55 and/or any other part of book 20 to not separate from chewable element 40, for example, when a child or other unaware user positions teeth on and/or chews on chewable element 40 and/or otherwise applies and/or creates a force, such as a pulling force and/or a pushing force, that is used to try and separate chewable element 40 and/or rattle 55 from page 24 and/or any other part of book 20. In some embodiments of this invention, 2 or more threads 32 and/or 2 or more of any other suitable securing and/or attaching device can be used to strengthen a holding force between chewable element 40, page 24, rattle 55 and/or any other part of book 20. This can be an important safety feature of this invention that allows a child to chew on book 20, including chewable element 40 and/or page 24, and not detach, remove and/or otherwise separate one or more pages 24 from chewable element 40 and/or any other part of book 20.

In some embodiments of this invention, all or at least a portion of each and every element or component of book 20, including but not limited to chewable element 40, rattle 55, spine 30, cover 22 and/or each page 24 is waterproof and/or water-resistant. In some embodiments of this invention, chewable element 40, rattle 55, spine 30, cover 22 and/or page 24 are made of or constructed from a durable and/or clean material, particularly a material that can withstand substantial pulling and tearing forces, for example, those forces created by a child or other user applying pushing forces and/or pulling forces to the material of chewable element 40, rattle 55, spine 30, cover 22 and/or each page 24.

In some embodiments of this invention, chewable element 40, rattle 55, spine 30, cover 22 and/or each page 24 is constructed of or made from a polymeric and/or a plastic material. Although any suitable material can be used to construct or make chewable element 40, rattle 55, spine 30, cover 22 and/or each page 24, in some embodiments of this invention, particularly when used by a child or other human user, for the safety of the child or other user, a child friendly material can be used, for example, any suitable thermoplastic elastomer (TPE) material or other similar material including but not limited to a flashspun high-density polyethylene fiber material and/or another suitable fiber synthetic material, such as thermoplastic rubbers which are a class of copolymers or a mixture of different polymers, such as plastic and rubber, that include materials with both thermoplastic and elastomeric properties. Any other suitable material can be used to construct, form and/or make chewable element 40, rattle 55, spine 30, cover 22 and/or each page 24 of this invention. In some embodiments of this invention, elements or components of book 20 are individual pieces or parts and in other embodiments of this invention, one or more of the elements or components of book 20 can be integrated to form one piece or part.

Particularly when the child is the user, each page 24 and/or cover 22 is preferably but not necessarily made of a material that is relatively durable and can be easily cleaned, particularly for sanitary reasons or purposes. In some embodiments of this invention, each page 24 and/or cover 22 is secured, attached and/or otherwise held in position directly or indirectly with respect to chewable element 40 and/or any other element or part of book 20, so that when a force, such as a pulling force and/or a pushing force, is applied then page 24 and/or cover 22, page 24 and/or cover 22 are not separated from and/or detached with respect to chewable element 40 and/or any other part of book 20.

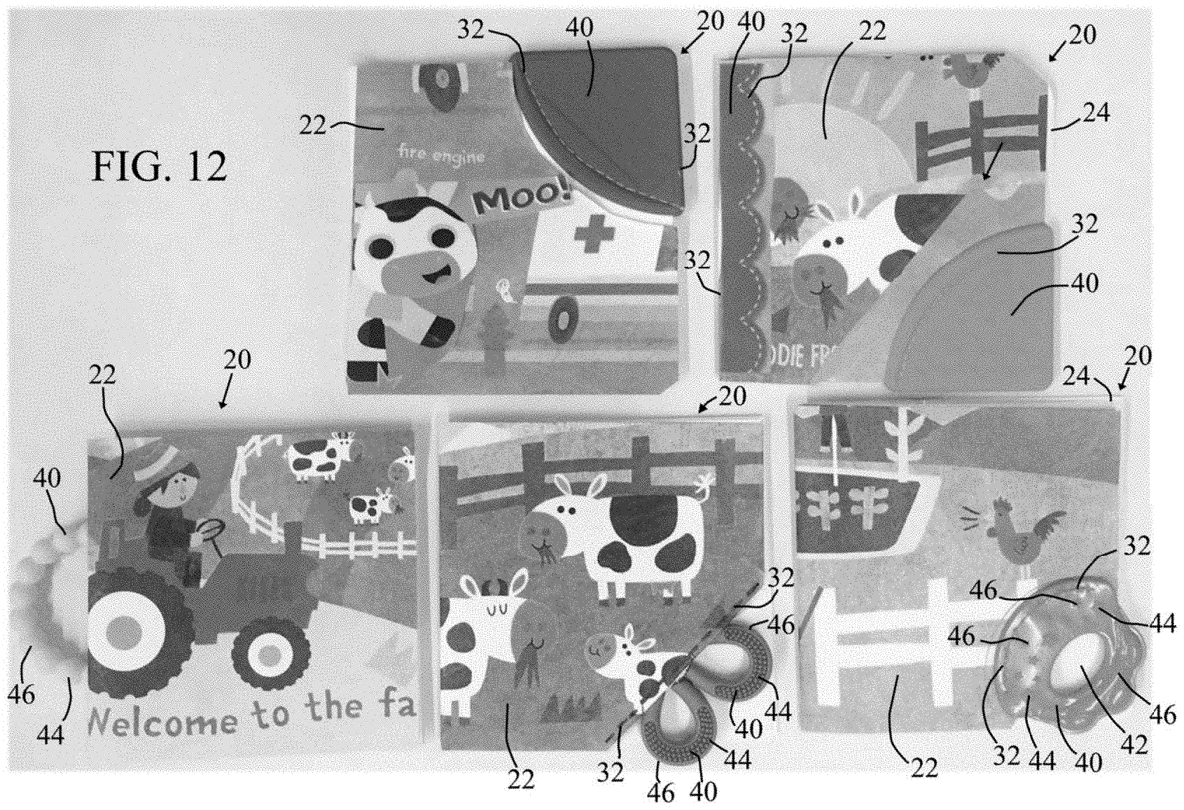

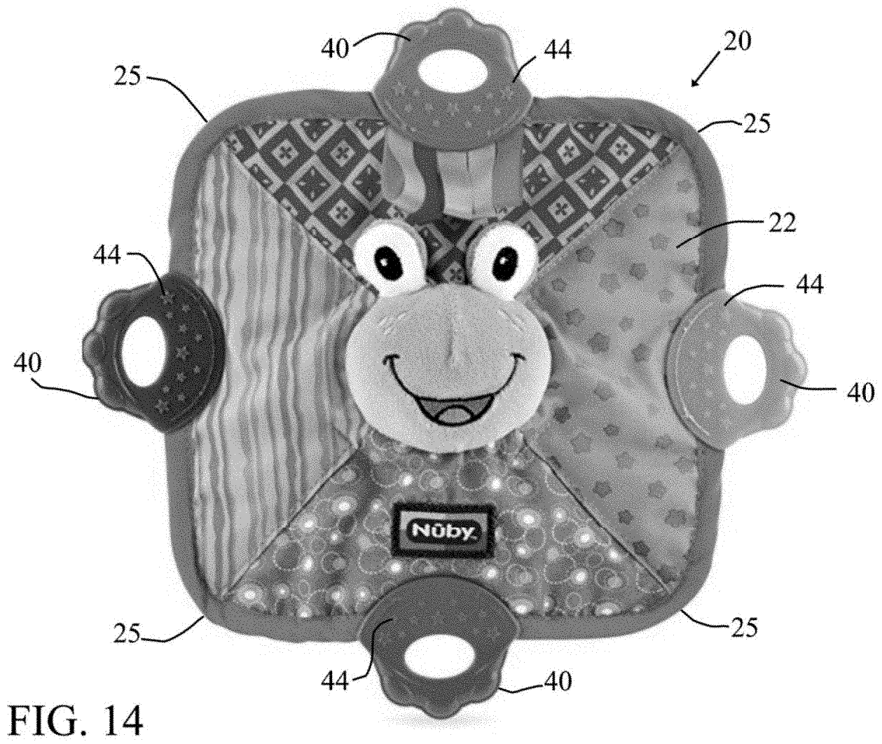

In some embodiments of this invention, book 20 further comprises a second chewable element 40 positioned preferably but not necessarily at a distance from or with respect to the first chewable element 40. For example, as shown in FIGS. 12 and 14-17, book 20 has a first chewable element 40 and a second chewable element 40 positioned at a distance from or with respect to the first chewable element 40. In other embodiments according to this invention, such as shown in FIGS. 14-17, book 20 comprises 3 or more chewable elements 40 positioned at different locations on or about book 20, with respect to each other. In other embodiments according to this invention, chewable element 40 and/or rattle 55 can have any suitable size, shape and/or design and/or can be constructed of any suitable material that allows chewable element 40 and/or rattle 55 to fit on and/or be positioned on or with respect to any suitable part and/or element of book 20, and that allows chewable element 40, page 24, rattle 55 and/or any other part of book 20 to be safely inserted into a mouth, such as of a child, and to structurally hold together all elements of book 20 and resist any applied pulling and/or pulling force, such as caused by chewing actions.

In some embodiments of this invention, each page 24 has rounded corners and/or any other suitably shaped corner and/or part of book 20 that provides a safety feature, for example, to prevent page 24, rattle 55 and/or any other part of book 20 from injuring a person, such as an eye and/or any other body part of a child or other user of book 20. In other embodiments of this invention, page 24, rattle 55 and/or any other part of book 20 can have any other suitable shape, size and/or design and/or can be of any other suitable material that allows or provides safety to a person, particularly a child.

According to some embodiments of this invention, chewable element 40 has or includes bore 42 within chewable element 40. In some embodiments of this invention, bore 42 extends completely through the material body of chewable element 40 and is thus a through bore. In other embodiments of this invention, bore 42 does not extend completely through the material body of chewable element 40 and is thus a closed bore. Bore 42 according to different embodiments of this invention can be used to secure, attach and/or otherwise fix the position of link 50 and/or any other suitable parts of chewable element 40 to hold and/or otherwise fix a position of book 20.

FIGS. 7-9 show different embodiments of chewable element 40 comprising at least one teether surface 44 positioned on or with respect to chewable element 40, such as on an exterior of chewable element 40. In some embodiments of this invention, teether surface 44 can be constructed of any suitable material, as discussed in this specification, particularly a material that is pleasing to or that stimulates the gum surfaces of a child.

In some embodiments of this invention, such as shown in FIGS. 8 and 9, chewable element 40 has a plurality of raised surfaces 46 extending above an exterior surface 41 of chewable element 40. Raised surfaces 46 can have any suitable shape, design and/or material, particularly when suitable for the purposes of a teething device. FIG. 7 shows chewable element 40 having a plurality of shapes 47 printed and/or otherwise positioned or appearing on exterior surface 41 of chewable element 40. Shapes 47 can have any suitable design, size and/or material, particularly when suitable for the purposes of a teething device.

According to some embodiments of this invention, a method for manufacturing or making book 20 includes forming a plurality of pages 24 and positioning spine 30 at, near and/or along edge portions 26 of pages 24. In some embodiments of this invention, chewable element 40 is arranged or positioned to at least partially cover edge portions 26 of pages 24, and edge portions 26 are secured to chewable element 40. In some embodiments of this invention, rattle 55 is attached to, connected to and/or otherwise held in position to or with respect to chewable element 40. Rattle 55 can have any suitable design, shape and/or size and can be constructed of any suitable material for the purpose of the teething device.

While in the foregoing detailed description this invention has been described in relation to certain embodiments, and many details have been set forth for purposes of illustration, it will be apparent to those skilled in the art that this invention is susceptible to additional embodiments and that certain of the details described herein can be varied considerably without departing from the basic principles of and desired results from this invention.

1. A chewable book comprising:
a plurality of pages, the pages having entire page lengths each extending from a page top of each page to a page bottom of each page, a spine positioned along edge portions of the pages, a chewable element fully covering the edge portions completely along the entire page lengths, the chewable element directly contacting the edge portions completely along the entire page lengths, and the edge portions of the pages permanently secured with respect to the chewable element completely along the entire page lengths.

2. The chewable book according to claim 1, wherein the chewable element has a through bore extending through the chewable element.

3. The chewable book according to claim 1, further comprising a second chewable element positioned at a distance from the chewable element.

4. The chewable book according to claim 1, wherein the chewable element has a teether surface having a plurality of raised surfaces extending above an exterior surface of the chewable element.

5. The chewable book according to claim 1, wherein the chewable element has a plurality of raised surfaces extending above an exterior surface of the chewable element.

6. The chewable book according to claim 1, wherein the chewable element has a plurality of shapes printed on an exterior surface of the chewable element.

7. The chewable book according to claim 1, wherein the pages are waterproof and/or water-resistant.

8. The chewable book according to claim 1, wherein the pages have rounded corners.

9. The chewable book according to claim 1, further comprising a rattle element attached to the chewable element and/or one of the pages.

10. The chewable book according to claim 1, wherein a stitched thread secures the edge portions to the chewable element.

11. A book comprising:
a plurality of pages, the pages having entire page lengths each extending from a page top of each page to a page bottom of each page, a spine positioned along edge portions of the pages completely along the entire page lengths, a chewable element fully covering and permanently secured to and directly contacting the edge portions completely along the entire page lengths, and the chewable element having a bore extending through the chewable element.

12. The book according to claim 11, further comprising a second chewable element positioned at a distance from the chewable element.

13. The book according to claim 11, wherein the chewable element has a teether surface having a plurality of raised surfaces extending above an exterior surface of the chewable element.

14. The book according to claim 11, wherein the chewable element has a plurality of raised surfaces extending above an exterior surface of the chewable element and/or a plurality of shapes printed on an exterior surface of the chewable element.

15. The book according to claim 11, further comprising a rattle attached to the chewable element and/or one of the pages.

16. A method for making a chewable book, the method including the steps of:
forming a plurality of pages having entire page lengths each extending from a page top of each page to a page bottom of each page;
positioning a spine along edge portions of the pages completely along the entire page lengths;
positioning a chewable element to fully cover and directly contact the edge portions completely along the entire page lengths; and
permanently securing the edge portions of the pages to the chewable element.

17. In the method according to claim 16, further including attaching a rattle to the chewable element and/or one of the pages.

18. In the method according to claim 16, further including forming a second chewable element positioned at a distance from the chewable element.

19. In the method according to claim 16, further including forming a teether surface having a plurality of raised surfaces extending above an exterior surface of the chewable element.

20. In the method according to claim 16, further including forming a plurality of raised surfaces extending above an exterior surface of the chewable element and/or forming a plurality of shapes printed on an exterior surface of the chewable element.
